(19) United States
(12) Patent Application Publication
(10) Pub. No.: US 2007/0130324 A1
(43) Pub. Date: Jun. 7, 2007

(54) Method for detecting non-responsive applications in a TCP-based network

(76) Inventor: Jieming Wang, Kanata (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/293,123

(22) Filed: Dec. 5, 2005

(51) Int. Cl. G06F 15/173

(52) U.S. Cl. 709/224

(57) ABSTRACT

A method for detecting a non-responsive condition of an application in a TCP/IP system comprises a step of monitoring a TCP/IP connection between a client and a server in order to detect an incomplete close sequence of the connection when the application has become not responding.

### FIELD OF THE INVENTION

The present invention relates to network Transfer Control Protocol (TCP)-based applications, and more particularly to a method and apparatus for detecting non-responsive applications in a TCP-based network.

### BACKGROUND OF THE INVENTION

The Internet, as a typical example of a TCP-based network, is a worldwide collection of computers and network devices, that generally use a Transfer Control Protocol/Internet Protocol (TCP/IP) suite of protocols to communicate with one another.

In a client-server environment of a TCP/IP system, for example as illustrated in FIG. 1, a client 30 accesses an application of a web server 40, for example a web page, through a TCP/IP connection between the client 30 and the web server 40. This TCP/IP connection is particularly associated with a socket of the application. Various protocols are used as upper layers in Internet communications over the TCP/IP connections for different applications. For example, the client application may communicate with the server application using Hypertext Transfer Protocol (HTTP) over the TCP/IP connection.

There are two types of application failures that can lead to a complete failure of a service. The first is an application or process crash where one or more processes of the service terminate abnormally and unexpectedly. The second is an application hang or application freezing wherein one or more processes/threads of the service appear to be running but have stopped responding.

It is reasonably simple to detect an application crash by monitoring its resources such as a process ID (PID), log message, and/or connection creation. For example, it can be determined that an application has not crashed as long as one or a combination of the following exists: the expected PID is present; no error/exception is found in the application log; and/or the application is still accepting new connections.

Therefore, conventional methods have been devised for monitoring the availability of TCP-based server applications and particularly for detecting an application crash. For example, a known method for monitoring availability of a TCP-based server application uses an agent to establish a TCP/IP connection to the server application. The application is detected as unavailable when the connection cannot be established successfully.

Another method for monitoring the availability of a server application is through monitoring use of computing resources, such as PID, memory and CPU usage associated with the application.

However, it is difficult to detect a hung application. In a non-responsive condition of a server application, computer resources used by the application, such as a PID, memory, CPU usage, etc., usually appear to be normal and the application is still able to accept new connections. Furthermore, no error/exception message appears in the application log when the application has become non-responsive.

Therefore, the above-mentioned conventional methods for monitoring the availability of an application cannot be used to detect a non-responsive condition of a server application.

Efforts to address the problem of detecting a non-responsive condition of TCP-based applications have been conventionally focused on the use of monitoring agents which communicate with the server application through a customized application programming interface (API). Such methods can accurately detect an application failure including application hang. However, this method suffers a disadvantage in that each application requires its own monitoring agent, because each application uses its own API and there is no common ground across various applications to develop a generic monitoring agent. Therefore, developing and maintaining individual customized agents for monitoring a large number of various applications is very expensive.

Accordingly, there is a need for a generic method and apparatus capable of detecting a non-responsive condition of various applications. It is understood that the terms “non-responsive condition of an application”, “non-responsive application” and “a hung application” used throughout this specification and appended claims mean that an application appears to be running but has become not responding, but which does not include application crash.

### SUMMARY OF THE INVENTION

One object of the present invention is to provide a method for detecting a non-responsive condition of server applications in a TCP-based network.

In accordance with one aspect of the present invention, there is a method for detecting a non-responsive condition of a server application in a TCP/IP system, the server application being normally responsive to a client through a TCP/IP connection. The method comprises: monitoring the TCP/IP connection to detect an incomplete close sequence of the TCP/IP connection, the incomplete close sequence being initiated by the client; and determining that the application is in a non-responsive condition when the incomplete close sequence is detected.

In accordance with another aspect of the present invention, there is a method for detecting a non-responsive condition of a server application in a TCP/IP system, the server application being normally responsive to a client through a TCP/IP connection. The method comprises a) executing a client process to alternately establish and close the TCP/IP connection at predetermined intervals; and b) monitoring the TCP/IP connection to detect an incomplete close sequence of the TCP/IP connection, thereby determining an occurrence of the non-responsive condition of the server application.

In accordance with a further aspect of the present invention, there is a system for detecting a non-responsive condition of a server application in a TCP/IP system. The system comprises a first subsystem for monitoring a TCP/IP connection through which the server application is normally responsive to a client, to detect an incomplete close sequence of the TCP/IP connection, the incomplete close sequence being initiated by the client, thereby determining an occurrence of the non-responsive condition of the server application.

The present invention advantageously provides a solution for detecting non-responsive applications in a client-server network environment at the TCP layer, and as a result, a generic tool can be provided to detect a non-responsive condition of all types of TCP-based server applications. Furthermore, because the present invention allows monitoring of an application at the TCP layer, it significantly reduces the overheads occurring at upper layers, thereby improving performance of the server application(s) being monitored and the monitoring system. For example, creating a secure socket layer (SSL) connection can dramatically increase computing overhead compared with a non-SSL connection. This overhead can be avoided by using the present invention because it is adapted to create native non-SSL connections to monitor any TCP-based server applications.

Another advantage of the present invention is easy deployment because tools developed in accordance with the present invention are application-independent, whereas conventional API-based monitoring agents require testing and verification whenever changes (e.g. software updates, installation of patches, etc.) are introduced. Furthermore, the present invention can be used to simplify developing and maintaining high availability systems such as a load balancing system and application cluster.

### BRIEF DESCRIPTION OF THE DRAWINGS

Further features and advantages of the present invention will become apparent from the following detailed description, taken in combination with the appended drawings, in which:

FIG. 1 is a schematic illustration of a prior art TCP-based client-server environment;

FIG. 2A schematically illustrates proper execution of a conventional four-way handshake for closing a TCP/IP connection between a client and a server, initiated by the client;

FIG. 2B schematically illustrates an incomplete close sequence which is initiated by the client to close the TCP/IP connection between the client and a server;

FIG. 3 is a flow diagram illustrating operation of a monitoring agent for detecting a FIN-WAIT-2 state of a TCP/IP connection in order to determine a non-responsive condition of an application in accordance with another aspect of the present invention;

FIG. 4 is a flow diagram illustrating operation of a monitoring agent for detecting a CLOSE-WAIT state of a TCP/IP connection in order to determine a non-responsive condition of an application in accordance with a further aspect of the present invention;

FIG. 5 is a flow diagram illustrating operation of a monitoring agent for detecting a missing FIN message in a TCP/IP connection in order to determine a non-responsive condition of an application in accordance with a still further aspect of the present invention;

FIG. 6 is a flow diagram illustrating operation of a client agent alternately initiating and terminating TCP/IP connections in accordance with an aspect of the present invention;

FIG. 7 schematically illustrates a combination of client agents and monitoring agents to monitor a non-responsive condition of a server application in a multi-tier environment in accordance with the present invention; and

FIG. 8 schematically illustrates a load balancing system incorporating a client agent and a monitoring agent in accordance with the present invention.

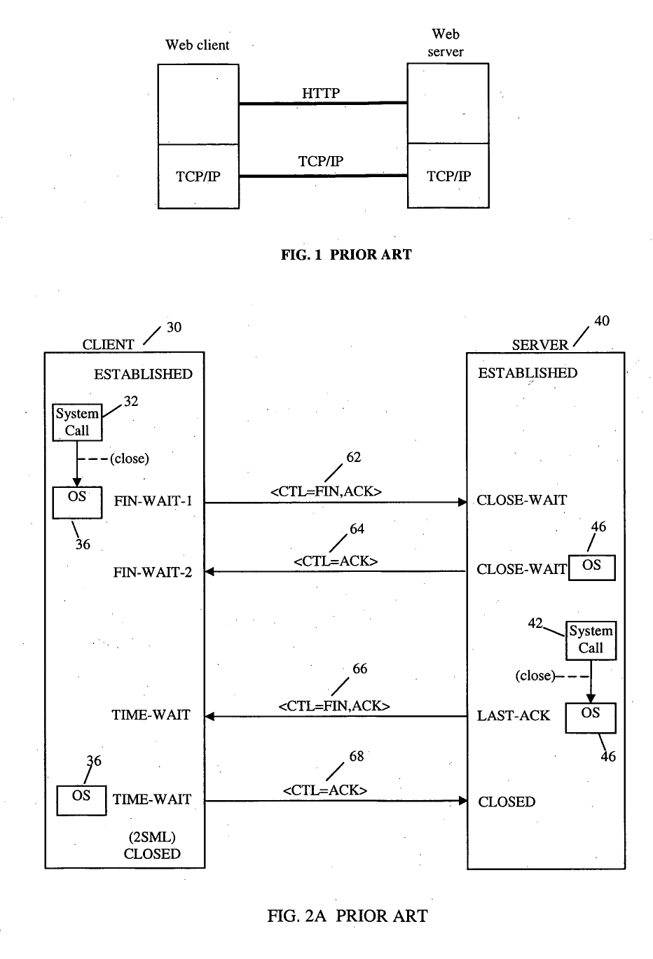

It should be noted that throughout the appended drawings, features are identified by like reference numerals.

### DETAILED DESCRIPTION OF THE PREFERRED EMBODIMENT

In general, the present invention enables generic detection of a hung application by monitoring TCP/IP connections associated with the application. Thus, the present invention is implemented at the TCP layer rather than the application layer, as in the prior art.

As is well known in the prior art, primary responsibility of TCP/IP is to establish and maintain a reliable connection between a client application and a server application through which the client and server applications can communicate. TCP/IP connections are uniquely identified by the IP address and TCP port at both the client and server ends. Each unique TCP/IP connection consists of a client IP address and a TCP port (or a client socket) as one part thereof, and a server IP address and a TCP port (or a server socket) as the other part thereof.

A TCP connection state can be different at the respective ends thereof and thus should be identified by either a local IP address with a local TCP port, or by a remote IP address with a remote TCP port. For convenience of description, the following definition is used throughout the present invention: “server address” represents an IP address and TCP port to which a TCP client can initiate a TCP connection to the server application. A “server application” also refers to a server program or server process.

A TCP/IP connection typically progresses through a series of states during its lifetime. These states include LISTEN, SYN-SENT, SYN-RECEIVED, ESTABLISHED,. FIN-WAIT-1, FIN-WAIT-2, CLOSE-WAIT, CLOSING, LAST-ACK, TIME-WAIT, and CLOSED. In many operating systems, the “_” in a state is replaced by “_”, for example, CLOSE_WAIT, FIN_WAIT_{—}2 (or FIN_WAIT2), etc.

LISTEN represents waiting for a connection request from any remote TCP client. SYN-SENT represents waiting for a matching connection request after having sent a connection request. SYN-RECEIVED represents waiting for a confirming connection request acknowledgement after having both received and sent a connection request. ESTABLISHED represents an open connection where data received can be delivered to a user (an application, program or process), and is the normal state for the data transfer phase of a TCP/IP connection. FIN-WAIT-1 represents waiting for a connection termination request from the remote TCP, or an acknowledgement of the connection termination request previously sent. FIN-WAIT-2 represents waiting for a connection termination request from the remote TCP. CLOSE-WAIT represents waiting for a connection termination request from the local user (also called user process or user program). CLOSING represents waiting for a connection termination request acknowledgment from the remote TCP. LAST-ACK represents waiting for an acknowledgment of the connection termination request previously sent to the remote TCP (which includes an acknowledgment of its connection termination request). TIME-WAIT represents waiting for enough time to pass to be sure the remote TCP received the acknowledgment of its connection termination request. CLOSED represents no connection state at all.

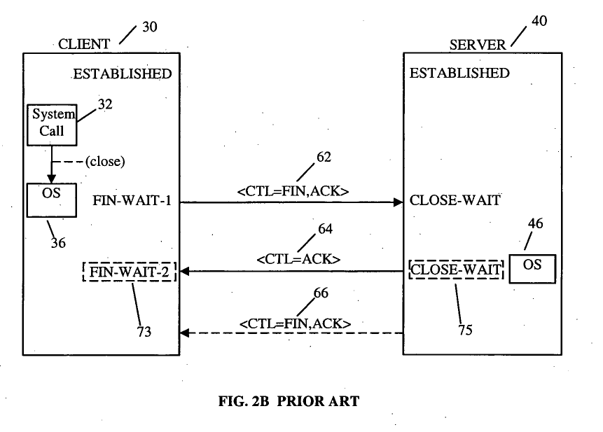

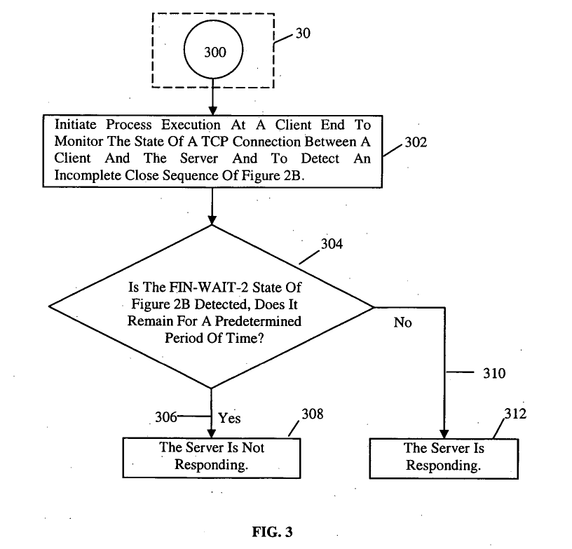

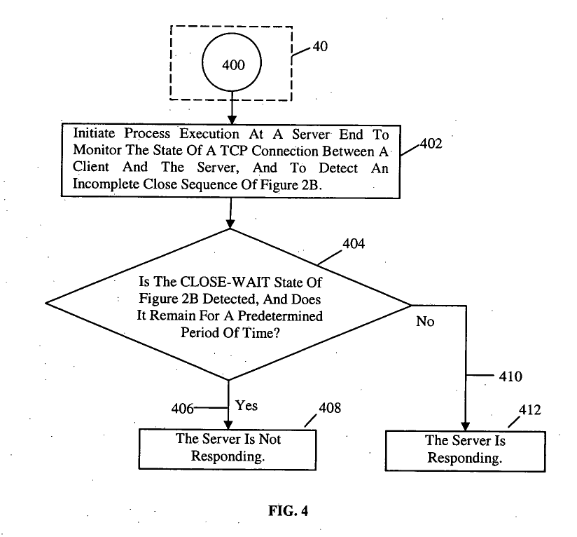

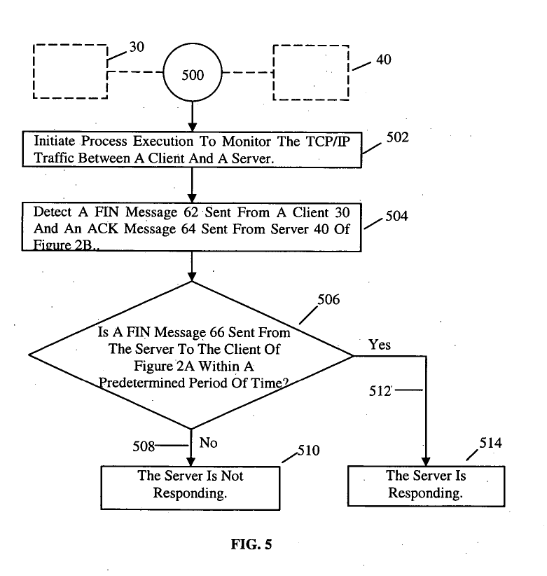

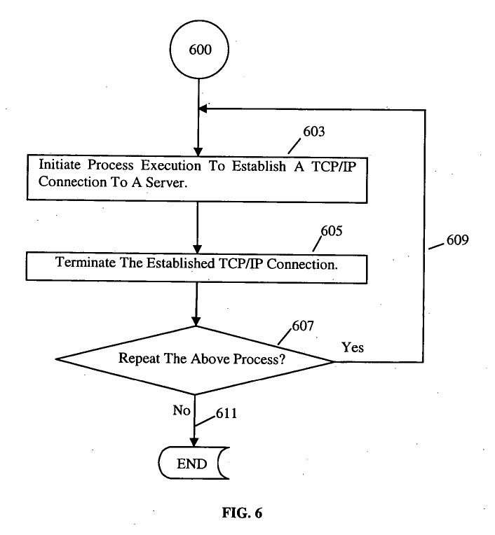

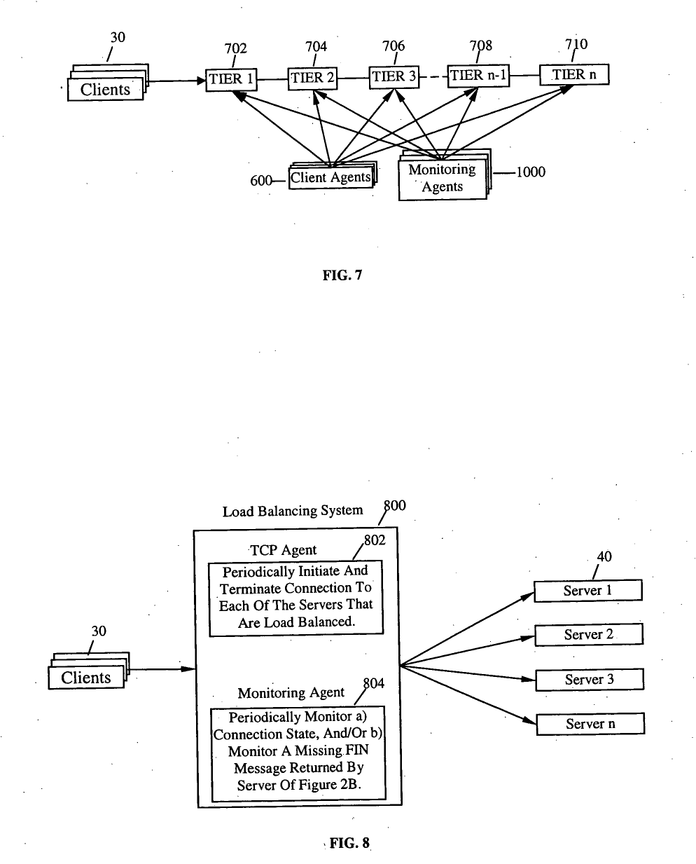

FIG. 2A schematically illustrates the normal close sequence of a TCP/IP connection with a four-way handshake when a client 30 actively closes the TCP/IP connection. The ESTABLISHED state illustrated at both ends of the client 30 and server 40, represents an established or existing TCP/IP connection therebetween which is to be terminated. The remainder of the illustrated states represents the respective states after the departure or arrival of messages 62, 64, 66 and 68. The following messages are shown in abbreviated form: control flags (CTL), acknowledge (ACK) and finish (FIN). Other fields such as sequence number (SEQ), maximum segment size (MSS), window, length, text and other parameters have been omitted for the sake of clarity. Inside the client 30 and server 40 there are included components 32 (a user level system call within a client process), 36 (a client operating system), 46 (a server operating system) and 42 (a user level system call within a server process) which are involved in sending the messages, and are executed by the respective client 30 and the server 40. It is also assumed throughout this invention that during termination of a TCP connection there is no packet loss.

The client 30 begins the four-way handshake by sending a FIN message 62 requesting the close of the established TCP/IP connection, and the state of such a connection at the client 30 is shown at this stage as a FIN-WAIT-1. Upon receipt of the FIN message 62, the server 40 is in a CLOSE-WAIT state. The server 40 responds to the client 30 with an ACK message 64 and remains in the CLOSE-WAIT state. Upon receipt of the ACK message 64 from server 40, client 30 is in a FIN-WAIT-2 state. Server 40 further issues its own FIN message 66 and changes to a LAST-ACK state. Client 30 changes to a TIME-WAIT state upon receipt of the FIN message 66 and then client 30 responds with a ACK message 68. Upon receipt of the ACK message 68 from the client 30, server 40 moves to a CLOSED state. The client end of this closed connection remains in the TIME-WAIT state for a period of time equal to two times the maximum segment lifetime (2MSL), before switching to a CLOSED state. The MSL is normally defined to be thirty seconds. The TIME-WAIT state limits the rate of successive transactions through the same TCP/IP connection because a new initiation of the connection cannot be opened until the TIME-WAIT delay expires.

For convenience of description the present invention is discussed in terms of a BSD sockets implementation found on most operating systems, although it will be understood that other operating systems will benefit equally from the invention. A process is typically executed in two levels (or modes): a user level and a kernel or OS (i.e., client OS 36 or server OS 46) level. Furthermore, the TCP is typically implemented as part of the. kernel (OS) which is responsible for sending/receiving TCP messages (e.g., 62, 64, 66 and 68 of FIG. 2A). A special function call which is also referred to as a system call, such as a close( ) , shutdown( ) or the like, must be initiated at the user level (system call 32 or system call 42). In contrast, no coding or functional call is required at the user level to inform the underlying operating system (36 or 46) to send an ACK message (64 or 68), which means that sending of an ACK message (64 or 68) is performed automatically by the operating system (36 or 46). Therefore, when an application executed on the server 40 becomes non-responsive, the execution of user level system call 42 is not performed to cause server OS 46 to send FIN message 66. As a result, the close sequence of a TCP/IP connection will not complete normally.

After the FIN message 62 is received by the server 40 an ACK message 64 is automatically returned to the client 30 unless the underlying operating system server OS 46 stops responding (i.e. OS failure). However, the second FIN message 66 must be actively initiated by executing the user level system call 42 (i.e., a close( ), or the like).

Referring now to FIG. 2B, in a non-responsive condition of the server application, the server 40 is not able to execute a system call to cause server OS 46 to send the returning FIN message 66 to the client 30. As a result, the TCP/IP connection at the server end will remain in the CLOSE-WAIT state unless server 40 is terminated. For the same reason, the TCP/IP connection at the client end will remain in the FIN-WAIT-2 state until this state is deleted by the underlying operating system client OS 36. The maximum time interval in which a FIN-WAIT-2 state can remain is tunable and usually varies between 60 seconds to 675 seconds on most operating systems.

In a normal sequence of termination of a TCP/IP connection, as illustrated in FIG. 2A, the individual states, FIN-WAIT-1, FIN-WAIT-2, and CLOSE-WAIT do not remain and exist only for a very short period of time, for example, a fraction of a second (omitting delay caused by the network), which in practice is nearly undetectable. Therefore, such an incomplete close sequence, as illustrated in FIG. 2B, can be used to determine a non-responsive condition of an application.

In such an incomplete close sequence, particularly the contained information therein, such as the FIN message 66 from server 40 to client 30 being missing in FIG. 2B, as indicated by a broken underline thereof, and the FIN-WAIT-2 or the CLOSE-WAIT state remaining over a predetermined period of time as indicated by the broken line blocks 73, 75 in FIG. 2B, can be used to determine a non-responsive condition of the application.

As embodiments of the present invention, methods for detecting a non-responsive condition of an application in a TCP-based client-server environment are therefore generally illustrated in respective FIGS. 3, 4 and 5.

In FIG. 3, a monitoring agent 300 is preferably installed in a network node where a client 30 initiates and terminates at least one TCP/IP connection to a server application. The monitoring agent 300 repeatedly initiates a process execution at predetermined intervals to monitor the TCP/IP connection, represented by block 302. The monitoring agent 300 detects the incomplete close sequence of the TCP/IP connection of FIG. 2B, particularly by detecting the FIN-WAIT-2 state of the TCP/IP connection at the client end thereof (i.e. the remote IP address with the TCP port of the connection matches the server address associated with the server application), which remains over a predetermined period of time, preferably 30 seconds. However, this can be adjusted according to specific requirements and/or environments (network delays), e.g., it can be reduced to 5 seconds or even less in some circumstances. To the question whether or not a FIN-WAIT-2 state of such a TCP/IP connection is detected, as represented by block 304, if the answer is YES as indicated by arrow 306, the monitoring agent 300 determines that the server application has become not responding as represented by block 308. When the server application is found to be not responding, a warning signal may be sent out or further recovery action may be taken by other computer components. If the answer to the question is NO as indicated by arrow 310, the monitoring agent 300 determines that the server is responsive as represented by block 312, and the monitoring process continues.

In FIG. 4, a monitoring agent 400 is preferably installed on a network node where the server 40 is installed, to accept requests for establishing and/or terminating TCP/IP connections associated with the application. The monitoring agent 400 repeatedly initiates a process execution at predetermined intervals to monitor the TCP/IP connection between the client and the server 40 as represented by block 402 in order to detect the incomplete close sequence of the connection, as shown in FIG. 2B. In particular, the monitoring agent 400 is detecting a CLOSE-WAIT state of such a TCP/IP connection at the server end (i.e. the local IP address with the TCP port of the connection matches the server address associated with the server application), which remains over a predetermined period of time, preferably 30 seconds. However, this can be reduced to 5 seconds or even less in some circumstances.

To the question whether or not a CLOSE-WAIT state associated-with the server port is detected as represented by block 404, if the answer is YES as indicated by arrow 406, the monitoring agent 400 determines that the server application has become non-responsive as represented by block 408. When the server application is found to be not responding an alarm signal may be sent out or further recovery action may be taken by other computer components. If the answer to the question is YES as indicated by arrow 410, the monitoring agent 400 determines that the server is responsive as represented by block 412, and the monitoring process continues.

In FIG. 5, a monitoring agent 500 is used to repeatedly initiate a process execution at predetermined intervals to monitor the TCP/IP traffic between a client and a server as represented by block 502. The TCP/IP traffic is associated with the server application. The monitoring agent 500 can be installed on any network node where the TCP/IP traffic can be captured. The monitoring agent 500 is used to detect the incomplete close sequence of FIG. 2B from the TCP/IP traffic, and particularly to detect the failure to send FIN message 66 to the client following the receipt of FIN message 62 from the client, as indicated by the broken underline of FIN message 66 of FIG. 2B. First the monitoring agent 500 detects FIN message 62 sent from the client 30 to the server 40 for terminating the established connection and then detects ACK message 64 from the server 40 acknowledging the receipt of the FIN message 62 from the client 30 as represented by block 504. To the question whether or not FIN message 66 is sent from the server to the client within a predetermined period of time as represented by block 506, if the answer is NO as indicated by arrow 508, the monitoring agent 500 determines that the server application has become non-responsive as represented by block 510. When the server application is found to be non-responsive, a warning signal may be sent out or further recovery action may be taken by other computer components. If the answer to the question is YES as indicated by arrow 512, the monitoring agent 500 determines that the server is responsive as represented by block 514, and the monitoring process continues.

It is understood that either a client or server can terminate an established TCP/IP connection therebetween. FIG. 2A illustrates only a scenario where the client initiates the termination of a TCP/IP connection and FIG. 2B illustrates an incomplete close sequence of FIG. 2A caused by the non-responsive condition of the server application. A scenario where the server initiates the termination of such a TCP/IP connection is not relevant and will not be discussed because the server is enabled to actively close the connection and is not in a non-responsive condition.

In some circumstances, a non-responsive condition of a server application may remain temporarily (a few seconds up to minutes). The present invention is also applicable to detect such a temporary non-responsive condition of a server application, should the temporary non-responsive condition remain over the predetermined period of time, for example, 30 or 5 seconds, set to the defined incomplete close sequence in accordance with the present invention.

The above-described methods of the present invention are used to detect an incomplete close sequence of FIG. 2B in an environment where a real client terminates the connection to a server application when the server application becomes non-responsive. A more active method has been developed to more quickly determine a non-responsive condition of the server application when it occurs, independent of the actions of real clients of the server application. A client agent is thus created as a virtual client of the server application alternately and repeatedly at a predetermined interval, to initiate a request for establishing and a request for closing a TCP/IP connection between the client agent and the server application.

In an embodiment of the present invention as shown in FIG. 6, a client agent 600 which is installed on a network node, initiates process execution to establish a TCP/IP connection to the server application, as represented by block 603. The client agent 600 then terminates the established TCP/IP connection as represented by block 605. Repeating (indicated by numeral 609) or not repeating (indicated by numeral 611) the steps represented by blocks 603 and 605 after a predetermined interval, for example 60 seconds which can be adjusted to be less or more depending on the particular environment, depends on the following circumstances. Generally, if termination of the established TCP/IP connection represented by block 605, is successful and completed, the answer to the question represented by block 607 should be YES and the process continues. When the termination step of the established TCP/IP connection represented by block 605 is not successful and an incomplete close sequence of the TCP/IP-connection, as shown in FIG. 2B, occurs (which indicates that the application has become non-responsive), the process for steps represented by blocks 603 and 605 may continue for a further predetermined period of time or may stop, depending on other considerations built into the design of the client agent 600.

As further embodiments of the present invention, the methods illustrated in FIGS. 3, 4, and 5 can be performed in a more effective manner when the client agent 600 of FIG. 6, is used in the TCP/IP system as a virtual client. The client agent 600 acts as a real agent to establish and close TCP/IP connections to a server although the client agent 600 communicates with the server application by directly using the TCP/IP protocol, rather than using upper layer protocols such as HTTP.

Instead of monitoring a TCP/IP connection to a server application established and terminated by a real client as above described with reference to FIGS. 3 and 4, the monitoring agent 300 or 400 monitors the TCP/IP connections to the server application, established and terminated by the client agent 600 to detect the incomplete close sequence of FIG. 2B. The other steps will be similar to those illustrated in FIGS. 3 and 4.

Instead of. monitoring the traffic through a TCP/IP connection to a server application established and terminated by a real client 30 as described with reference to FIG. 5, the monitoring agent 500 monitors the traffic through a TCP/IP connection to the server application established and terminated by the client agent 600. The other steps will be similar to those illustrated in FIG. 5.

In these embodiments which use both monitoring agent (300, 400 and 500) and client agent 600, the detection of a non-responsive condition of a server application is active because it is independent of a real client behavior and is adjustable to a desired level of performance. The client agent 600 can be installed on any network node, including a node independent of a location where a real client or the server is installed, when the client agent 600 is used together with the monitoring agent 300, 400 and 500.

The use of client agent 600 for actively establishing and terminating a TCP/IP connection associated with a server application, allows quick diagnosis of a non-responsive condition of the server application when the server application has become non-responsive because the intervals between the initiation and termination of the connection can be predetermined according specific needs. It is understood that the server application still accepts the establishment of new connections, even when the non-responsive condition of the server application occurs at a moment after the client agent 600 terminates a previous connection.

In order for a server application to accept a new connection, a system call within the server such as a listen ( ) (for applications developed in C programming language), or a ServerSocket( ) (for applications developed in Java programming language), or similar calls for applications developed in other programming languages, is required. Such a system call (usually together with other system calls) causes the server application (program) to listen for connections on a socket.

Furthermore, such a system call typically includes a parameter called BACKLOG which defines the maximum number of connections (or length of the queue of pending connections) which can be established by the underlying operating system (kernel). The default value of the BACKLOG varies from 3 to 5 on most operating systems. Typically, for most Internet server applications such as a web server, the value of BACKLOG is set to be in the range of hundreds to thousands in order to handle a large number of connections. Therefore, when a server application becomes not responding, it is still able to accept new connection requests until the BACKLOG (queue) is full and, therefore, it can take a long time to fill such a large backlog. Once the BACKLOG is full, the server application will then refuse to accept new connections. A client is able to establish a new connection before the BACKLOG (queue) is full when a non-responsive condition of the application occurs. When the new connection which is established after the server application has already become non-responsive, is terminated, the incomplete close sequence of the TCP/IP connection can be detected.

It should be noted that in a practical situation in which a server application is adjusted with a reasonable setting for BACKLOG, the BACKLOG will not likely be full when the application is normally responsive. Nevertheless, when the application has become non-responsive, the server application still accepts requests for new connections which will be left pending, and the BACKLOG will eventually become full. When the BACKLOG becomes full, the server application will immediately refuse to accept the establishment of any new connections. However, the server socket will remain in a LISTEN state.

In a very rare situation, a CLOSE-WAIT state of a TCP/IP connection remains, where the local IP address and local TCP port are associated with the server address, until the process associated with the connection is terminated, due to factors other than a non-responsive condition of the server application. For example, this can occur when the system call (e.g. close( ), shutdown( ) or similar function calls) is missing within the program code, which may happen in an immature (usually new and not thoroughly tested) software product. As a result, the server application will never send the FIN message to terminate the connection after receiving a connection termination request, i.e. the FIN message from the client, even though the server may remain responsive. However, the application will eventually crash or become non-responsive because of exhaustion caused by too many incomplete connections. This problem rarely occurs in production environments because such a problem is usually obvious and can be readily identified during software development and testing cycles, and therefore in practical application, it is anticipated that this will not affect the result of the present invention. In rare circumstances where a server application executes multiple processes/threads, one or more process(es)/thread(s) of the server application stop(s) responding but the rest of the process(es)/thread(s) continues to respond. This represents a partially non-responsive condition of a server application. Such a condition can also be detected by using the monitoring methods of the present invention. The term “non-responsive condition” used throughout the specification and the appended claims includes such a partially non-responsive condition of a server application.

The present invention has broad applications, which cannot be exhaustively described herein. The following are two examples of broad applications of the present invention, which are presented as exemplary only and should not be construed to limit implementation of the present invention.

FIG. 7 illustrates a scenario of monitoring a multi-tier application (the service 700) which typically includes multiple tiers 702, 704, 706, 708 and 710. It is understood that all tiers can be on one network node or on different network nodes. In this case, TIER 1 which is indicated by numeral 702 functions as a front end of service 700. All communications between the clients 30 and TIER 1(702), between TIER 1(702) and TIER 2(704), between TIER 2(704) and TIER 3(706), between TIER 3(706) and TIER n-1(708) and between TIER n-1(708) and TIER n (710) are through TCP/IP connections. When a client 30 sends a request to TIER 1(702), TIER 1(702) will communicate with TIER 2(704) and TIER 2(704) will communicate with TIER 3(706), and so on, until finally TIER n-1(708) communicates with TIER n(710) to complete the request. Failure (including a non-responsive condition) in any one of those tiers can cause TIER 1(702) (i.e. service 700) to fail. Without an end-to-end monitoring program, it is very difficult to identify which tier is the source of the failure. Conventionally, troubleshooting failure caused by hung application in a multi-tiered environment is time consuming, and is usually very costly.

Such a multi-tiered server application environment can be monitored end-to-end by using monitoring agent(s) 1000 which executes one or more processes on at least one network node for monitoring connections to the individual tiers, detecting incomplete close sequence thereof. More particularly, monitoring agent(s) 1000 can be configured to correspond with any one of the monitoring agents 300, 400 and 500 of the respective FIGS. 3, 4 and 5, in order to detect a FIN-WAIT-2, CLOSE-WAIT or a missing FIN message, as described in previous embodiments. Once one or more such incomplete close sequences are detected, the IP addressing information, for example, an IP address with a TCP port, can be used to determine which tier is not responding. When more than one tier are determined to be not responding, one of the non-responsive tiers located most distant from the front end of the service 700 (TIER 1(702) in this case) will be considered the source of the non-responsiveness. For example, if TIERS 1-3 (702, 704 and 706) are determined to be not responding, TIER 3 is likely the source of the problem and should be further examined because TIERS 1 and 2(702, 704) are likely operating normally but are waiting for a response from the downstream line tier(s).

It is preferable to use the monitoring agent(s) 1000 with client agent 600 the function of which is illustrated in FIG. 6 and will not be further described in detail. At least one of client agent(s) 600 is installed on at least one network node to initiate a process execution for alternately establishing and closing a TCP/IP connection to the respective tiers 702, 704, 706, 708 and 710 at predetermined intervals. The monitoring agent(s) 1000 monitor(s) the state of those connections between the client agent(s) 600 and the respective tiers such that the monitoring agent (s) 1000 will more effectively detect a non-responsive condition of the service 700 and will identify the tier which is the source of the problem. It is understood that the monitoring agent(s) 1000, the client agent(s) 600 and all tiers (server applications) can be on a single network node or on different network nodes.

FIG. 8 illustrates another embodiment of the present invention in which the present invention is incorporated into a load balancing system 800 which can be software based or hardware based system. A load balancing system is conventionally used to provide a cluster or high availability environment in which a plurality of the same applications are running behind the load balancing system. When one application fails the load balancing system will automatically switch requests from clients to other applications. However, no one of conventional load balancing systems can detect a non-responsive condition of a server application and therefore, conventional load balancing systems will fail to switch connections from a non-responsive server application to other server applications.

Therefore, the result of use of conventional load balancing systems is limited.

In accordance with this embodiment of the present invention, a client agent 802 and monitoring agent 804 are integrated into the load balancing system 800. In such an environment, the clients 30 send requests through a TCP/IP connection to the load balancing system 800 which in turn forwards the requests to the respective servers 40 according to the load conditions and the availability of each server. The client agent 802 periodically at predetermined intervals, initiates and terminates a connection to each of the servers 40. The monitoring agent 804 continuously monitors the state of the respective connections between the client agent 802 and server 40 in order to detect any incomplete close sequence thereof as shown in FIG. 2B. One of the servers 40 is determined to be in a non-responsive condition if a FIN-WAIT-2 state of a TCP connection (as shown in is detected where the remote IP address with the remote TCP port matches the server address associated with one of the servers 40), and such a state remains for more than a predetermined period of time, as shown by the broken line block 73 in FIG. 2B, or if an expected FIN message 66 is not sent from the server within a predetermined period of time, as shown by the broken underline thereof in FIG. 2B. The detailed performance steps of client agent 802 and monitoring agent 804 are similar to the methods described with respect to previous embodiments of the present invention, and will not be further described herein. The monitoring agent 804 incorporated into the load balancing system 800 without client agent 802 can perform similar functions to detect a non-responsive condition of any of the servers 40 in order to provide availability information to the load balancing system 800. Nevertheless, use of the client agent 802 makes non-responsive application detection more efficient.

It is understood that in any of the described embodiments of the present invention, further recovery actions can be taken when a non-responsive condition of an application is identified. The recovery actions are conventionally monitored by monitoring relevant process ID (PID). In accordance with the present invention, the information contained in the incomplete close sequence which is detected to determine the occurrence of the non-responsive condition of the application, can also be used to monitor the status of recovery actions.

It can be determined that the application (process) remains in a non-responsive condition and no recovery action has been taken when any of the existing CLOSE-WAIT connections (sockets) remains. If all existing CLOSE-WAIT connections disappear and the server port(s) associated with the application are not in a LISTEN state, it can be determined that the application (process) is shut down but not restarted. If all existing CLOSE-WAIT connections disappear and the relevant server port(s) are in a LISTEN state again, it can be determined that the application (process) has been shut down and successfully restarted.

The above description is meant to be exemplary only, and one skilled in art will recognize that changes may be made to the embodiments described without departing from the scope of the invention disclosed. The inventive concept of a non-responsive application detection method as described herein may be implemented in various devices, systems, computer products and the like. Modifications which fall within the scope of the present invention will be apparent to those skilled in the art, in light of a review of this disclosure, and such modifications are intended to fall within scope of the appended claims.

I/we claim:

1. A method for detecting a non-responsive condition of a server application in a TCP/IP system, the server application being normally responsive to a client through a TCP/IP connection, the method comprising:
monitoring said TCP/IP connection to detect an incomplete close sequence of said TCP/IP connection, said incomplete close sequence being initiated by the client; and
determining that the application is in a non-responsive condition when said incomplete close sequence is detected.

2. The method as claimed in claim 1 wherein said incomplete close sequence comprises a CLOSE-WAIT state of said TCP/IP connection at a server end thereof, remaining over a predetermined period of time.

3. The method as claimed in claim 1 wherein said incomplete close sequence comprises a FIN-WAIT-2 state of said TCP/IP connection at a client end, thereof, remaining over a predetermined period of time.

4. The method as claimed in claim 1 wherein said incomplete close sequence comprises a failure to send a FIN message to the client following receipt of a FIN message from the client.

5. The method as claimed in claim 1 wherein said incomplete close sequence remains more than 5 seconds.

6. The method as claimed in claim 1 further comprising executing a client process on the client to alternately establish and close said TCP/IP connection at predetermined intervals.

7. A method for detecting a non-responsive condition of a server application in a TCP/IP system, the server application being normally responsive to a client through a TCP/IP connection, the method comprising:
(a) executing a client process to alternately establish and close said TCP/IP connection at predetermined intervals; and
(b) monitoring said TCP/IP connection at predetermined intervals, to detect an incomplete close sequence of said TCP/IP connection, thereby determining an occurrence of said non-responsive condition of the server application.

8. The method as claimed in claim 7 wherein the incomplete close sequence of said TCP/IP connection is detected when any one of the following factors is identified and remains over a predetermined period of time:
(a) a FIN-WAIT-2 state of said TCP/IP connection at a client end thereof;
(b) a CLOSE-WAIT state of said TCP/IP connection at a server end thereof; or
(c) failure to send a FIN message to the client following receipt of a FIN message from the client.

9. The method as claimed in claim 7 wherein step (a) comprises at said predetermined intervals, alternately establishing and closing respective TCP/IP connections between the client and respective tiers of the server application; and wherein step (b) comprises monitoring a plurality of close sequence sessions of said respective TCP/IP connections.

10. The method as claimed in claim 7 wherein step (a) comprises at said predetermined intervals alternately establishing and closing respective TCP/IP connections between the client and a plurality of servers associated with server applications identical to said server application; and wherein step (b) comprises monitoring a plurality of close sequence sessions of said respective TCP/IP connections.

11. A system for detecting a non-responsive condition of a server application in a TCP/IP system, the system comprising a first subsystem for monitoring a TCP/IP connection through which the server application is normally responsive to a client, to detect an incomplete close sequence of the TCP/IP connection, the incomplete close sequence being initiated by the client, thereby determining an occurrence of said non-responsive condition of the server application

12. A system as claimed in claim 11 comprising a second subsystem for executing a client process to alternately establish and close said TCP/IP connection at predetermined intervals.

13. A system as claimed in claim 11 wherein the first subsystem is adapted to identify any one of the following factors:
(a) a FIN-WAIT-2 state of said TCP/IP connection at a client end thereof;
(b) a CLOSE-WAIT state of said TCP/IP connection at a server end thereof; or
(c) failure to send a FIN message to the client following receipt of a FIN message from the client.
